(19) United States
(12) Patent Application Publication
(10) Pub. No.: US 2011/0115899 A1
(43) Pub. Date: May 19, 2011

(54) COMPONENT MOUNT SYSTEM

(75) Inventors: Kenichi Kaida, Osaka (JP); Noboru Higashi, Yamanashi (JP); Kazuhide Nagao, Yamanashi (JP); Yoshiaki Awata, Yamanashi (JP); Hideki Sumi, Yamanashi (JP)

(73) Assignee: PANASONIC CORPORATION, Osaka (JP)

(21) Appl. No.: 13/002,873

(22) PCT Filed: Jul. 9, 2009
(86) PCT No.: PCT/JP2009/003212

§ 371 Date: Jan. 6, 2011

(30) Foreign Application Priority Data
Jul. 14, 2008 (JP) 2008-182228

(51) Int. Cl. H04N 7/18; G06K 9/00

(52) U.S. Cl. 348/87; 382/149; 348/E07.085

(57) ABSTRACT

A component mount system includes: a component placing unit; an inspection unit; a repair station; an image display device; a defective portion image display unit configured to display an image of a defective portion of a board on the image display device; an input device; and a repair required portion display unit configured to display a defective portion detected by the inspection unit, which is indicated as a true defective portion in a determination result input through the input device and selected from the defective portion detected by the inspection unit, as a repair required portion on the image display device. The image display device is provided at a location where an operator who performs a repair work can watch the image displayed on the image display device, and the input device is provided at a location where the operator can operate the input device.

### TECHNICAL FIELD

The present invention relates to a component mount system including component placing means for placing a component on a board, inspection means for detecting a defective portion on the board by performing appearance check of the board, and a repair station where a repair work is performed for the board after the appearance check is performed thereto by the inspection means.

### BACKGROUND ART

The component mount system includes: a solder coating machine for coating a board with solder; a component placement machine for placing a component on the board coated with the solder by the solder coating machine; and a reflow oven for subjecting the board with the components to reflow soldering. In addition to the machines described above, the component mount system also includes an inspection machine for detecting a defective portion on the board by performing an appearance check to the board before or after the placement of the component, that is, immediately before the placement of the component or immediately before the reflow soldering. The inspection machine recognizes an image of a board surface by a camera, thereby detecting a portion where a coated state of solder is defective or a portion where a placement state of a component is defective. The inspection machine then marks the detected defective portion so as to indicate an operator that the portion is a “repair required portion.” The board indicated as including the repair required portion by the inspection machine is handled as a “repair required board.” The defective portion is repaired (e.g., to correct a positional displacement of solder or the component) at a repair station provided downstream of the inspection machine or outside the component mount system (see Patent Document 1).

As described above, the inspection machine determines whether a component placement portion of the board (a portion where a component is to be placed or a portion where a component is already placed) is defective through the image recognition using the camera. In the determination, if a criterion is rigorously set, the inspection machine may cause an “excess determination” which is to determine a portion as defective although the portion is not actually defective. When the inspection machine has caused an excess determination, a board that is not actually a repair required board is handled as a repair required board. As a result, production efficiency of the board is deteriorated. For this reason, some inspection machines displays an image of a detected defective portion on an image display device provided in the inspection machine so as to request the operator to determine whether the portion is a true defective portion (to make a true/false determination), thereby determining, as a repair required portion, only the portion for which the operator has input a determination result showing that the portion is a true defective portion.

### RELATED ART DOCUMENT

### Patent Document

Patent Document 1: JP-A-2000-252683

### SUMMARY OF THE INVENTION

### Problem to be Solved by the Invention

However, the repair station and the inspection machine are not always provided adjacent to each other. Even when they are disposed adjacently, it is difficult for a single operator to perform a board repair work performed at the repair station and a true/false determination work for a defective portion performed in the vicinity of the inspection machine (including an input of a determination result). For these reasons, it is necessary to arrange operators for the board repair work and for the true/false determination work for the detected defective portion on the board, respectively, which deteriorates working efficiency.

An object of the present invention is to provide a component mount system which allows one operator to perform the board repair work and the true/false determination work for the detected defective portion on the board, thereby enhancing working efficiency.

### Means for Solving the Problem

A component mount system according to a first aspect of the invention comprises: component placing means for placing a component on a board; inspection means for detecting a defective portion on the board by performing appearance check of the board before or after a placement of the component by the component placing means; a repair station in which a repair work is performed for the board which is transferred after the appearance check is performed by the inspection means; an image display device on which an image is displayed; defective portion image display means for displaying an image of the defective portion of the board detected by the inspection means on the image display device; an input device configured to input a determination result by an operator who performs the repair work for the board at the repair station as to the image of the defective portion displayed on the image display device by the defective portion image display means; and repair required portion display means for displaying a defective portion, which is indicated as a true defective portion in the determination result input through the input device and selected from the defective portion on the board detected by the inspection means, as a repair required portion on the image display device, wherein the image display device is provided at a location where the operator who performs the repair work for the board at the repair station can watch the image displayed on the image display device, and the input device is provided at a location where the operator who performs the repair work for the board at the repair station can operate the input device.

According to a component mount system of a second aspect of the invention, in the above-described component mount system, the image display device and the input device are provided at the repair station.

According to a component mount system of a third aspect of the invention, in the above-described component mount system, the repair required portion display means stores an image of the repair required portion in storage means, reads the image of the repair required portion on the board from the storage means after the board with the repair required portion is transferred to the repair station, and displays the read image on the image display device.

According to a component mount system of a fourth aspect of the invention, in the above-described component mount system, the inspection means and the component placing means are provided in a single component mounting machine configured to perform the appearance check of the board and places the component on the board while positioning the board at a work position, the inspection means performs the appearance check of the board before the placement of the component, for detecting the defective portion of a component placement position on the board, and the component placing means places the component on a component placement position determined by subtracting the repair required portion from the component placement position on the board to which the appearance check is performed by the inspection means.

### Advantages of the Invention

According to the present invention, the image display device on which the image of the defective portion on the board detected by the inspection means is displayed is provided at a location where the operator who performs the repair work for the board at the repair station can watch the image displayed on the image display device. Further, the input device configured to input a determination result whether the defective portion is true or false based on the image of the defective portion displayed on the image display device is provided at a location where the operator who performs the repair work for the board at the repair station can operate the input device. Accordingly, the operator who performs the repair work for the board at the repair station can check the defective portions by the image while performing the repair work for the board, and can determine whether the defective portion is true or false. Therefore, according to the present invention, one operator can perform the repair work for the board and the true/false determination work for the detected defective portion on the board, thereby enhancing the working efficiency.

### BRIEF DESCRIPTION OF THE DRAWINGS

FIG. 1 is a block diagram of a component mount system according to an embodiment of the present invention.

FIG. 2 is a plan view of a part of the component mount system according to the embodiment of the present invention.

FIG. 3 is a side view of a component placement machine according to the embodiment of the present invention.

FIG. 4 is a block diagram showing a control system of the component placement machine according to the embodiment of the present invention.

FIG. 5 is a plan view of a board according to the embodiment of the present invention.

### MODE FOR CARRYING OUT THE INVENTION

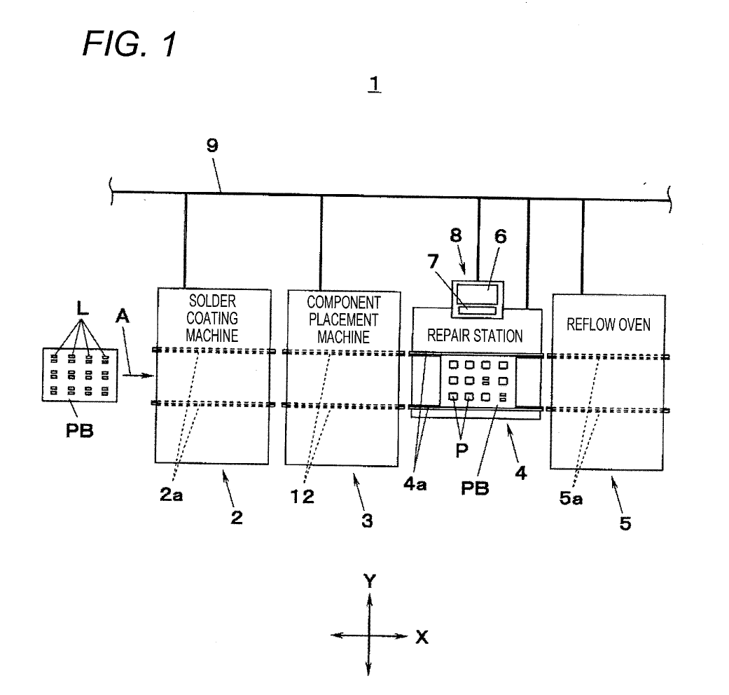

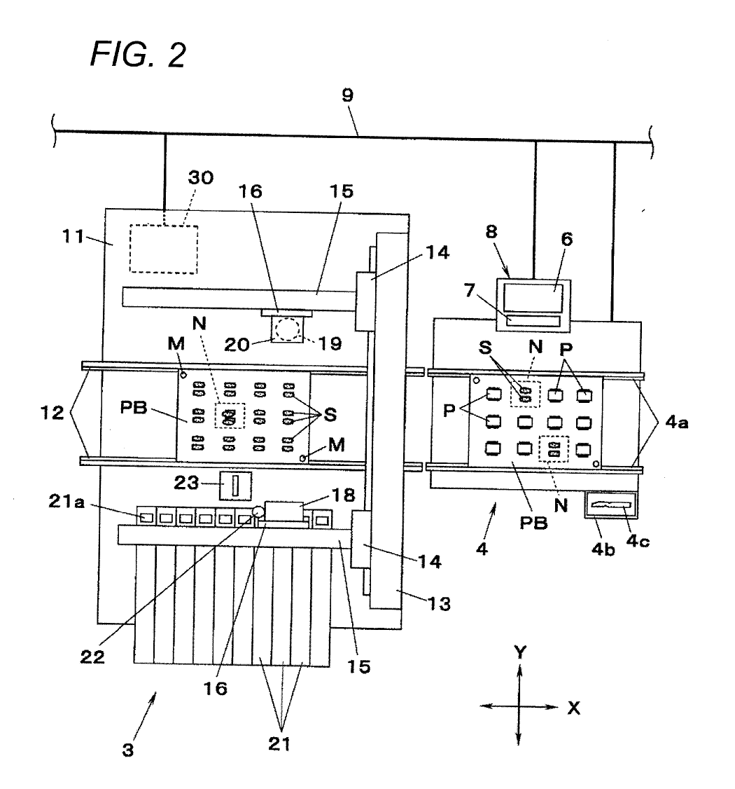

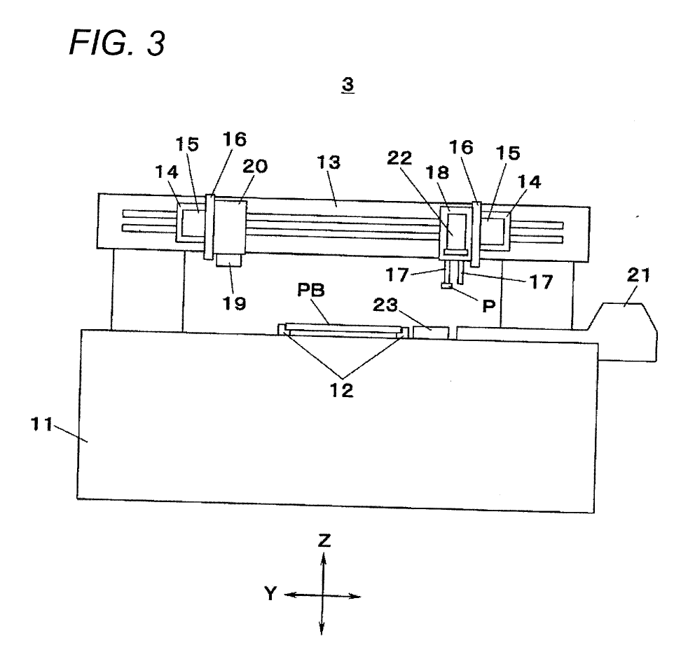

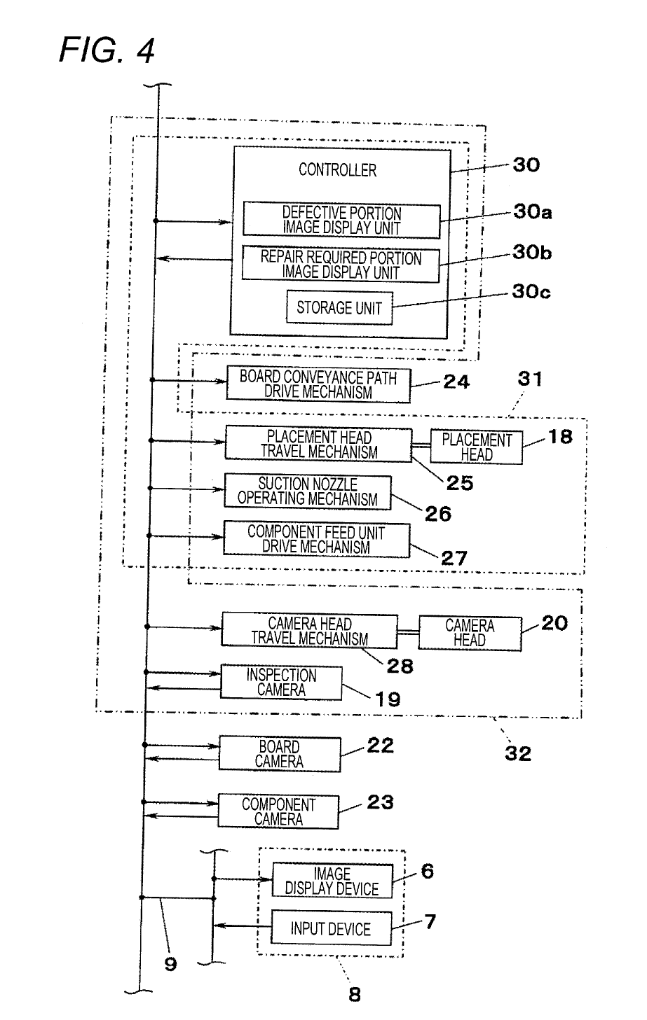

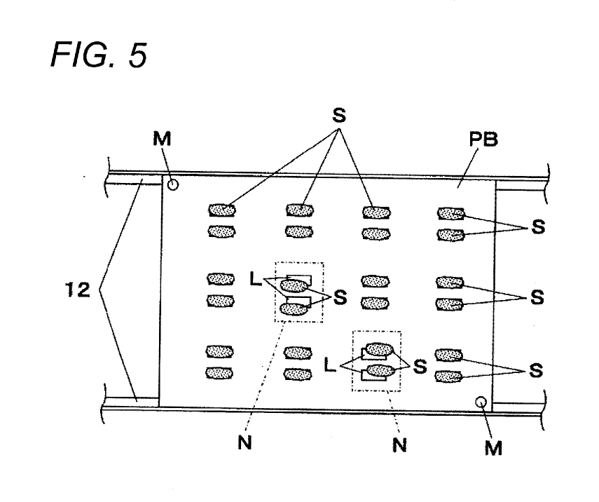

An embodiment of the present invention is hereinafter described with reference to the drawings. FIG. 1 is a block diagram of a component mount system according to an embodiment of the present invention, FIG. 2 is a plan view of a part of the component mount system of the embodiment according to the present invention, FIG. 3 is a side view of a component placement machine according to the embodiment of the preset invention, FIG. 4 is a block diagram showing a control system of the component placement machine according to the embodiment of the present invention; and FIG. 5 is a plan view of a board according to the embodiment of the present invention.

In FIG. 1, a component mount system 1 includes a solder coating machine 2, a component placement machine 3, a repair station 4, and a reflow oven 5, which are provided in this order. The repair station 4 includes an input/output unit 8 which includes an integrated image display device (a display) 6 and input device 7. These machines and devices are connected to a LAN cable 9 forming a local area network (LAN) and capable of exchanging information with one another. Further, a worker (an operator) of the component mount system 1 can obtain various pieces of information on the devices through the images displayed on the image display device 6 and also can enter a required input to each of the machines and devices through the operation of the input device 7.

The image display device 6 and the input device 7 may be configured as independent devices in the input/output unit 8 or may be configured as an integrated (single) unit such as a touch screen. The image display device 6 and the input device 7 are provided as a single unit at a single location in the embodiment, but may be provided as mutually-different devices and disposed at different locations, respectively.

In FIG. 1, the solder coating machine 2 includes a board conveyance path 2a including a pair of belt conveyors configured to convey a board PB in a horizontal direction (an X-axis direction). The solder coating machine 2 receives the board PB loaded in an arrow direction A shown in FIG. 1 by the board conveyance path 2a. The solder coating machine 2 conveys the received board PB along the X-axis direction and positions the board PB at a predetermined work position in the solder coating machine 2. The coating machine 2 applies solder to component placement positions (scheduled component placement positions) L on the board PB. After the solder is applied to the component placement positions L on the board PB, the solder coating machine 2 conveys the board PB to the outside (to the component placement machine 3) by the board conveyance path 2a.

In FIGS. 1, 2, and 3, the component placement machine 3 includes a board conveyance path 12 on a base 11 and including a pair of belt conveyors configured to convey the board PB in the X-axis direction. A Y-axis table 13 extending in a direction (a Y-axis direction) horizontally and perpendicular to the X-axis direction is placed above the board conveyance path 12. On a side surface of the Y-axis table 13, Y-axis sliders 14 independently movable in the Y-axis direction are provided. One ends of X-axis tables 15 extending in the X-axis direction are attached to the respective Y-axis sliders 14, and travel stages 16 movable in the X-axis direction are provided on the respective X-axis tables 15. A placement head 18 including a plurality of suction nozzles 17 extending downward is attached to one of the travel stages 16. A camera head 20 including an inspection camera 19 having an image incident surface oriented downward is attached to the other of the travel stages 16.

In FIGS. 1, 2, and 3, a plurality of component feed units (e.g., tape feeders) 21 configured to feed a component P to the placement head 18 are arranged along the X-axis direction and in a side region of the placement head 18 of the board conveyance path 12. A board camera 22 having an image incident surface oriented downward is provided on the placement head 18, and a component camera 23 having an image incident surface oriented upward is provided on the base 11.

In FIG. 4, the component placement machine 3 includes a board conveyance path drive mechanism 24 configured to drive the board conveyance path 12. The component placement machine 3 also includes a placement head travel mechanism 25 configured to allow one of the Y-axis sliders 14 for the placement head 18 to travel along the Y-axis table 13 and allow one of the travel stages 16 for the placement head 18 (i.e., the placement head 18) to travel along the X-axis table 15. The component placement machine 3 includes a suction nozzle operating mechanism 26, a component feed unit drive mechanism 27, and a camera head travel mechanism 28. The suction nozzle operating mechanism 26 individually raises or lowers the suction nozzles 17 provided on the placement head 18 and also individually rotates the suction nozzles 17 around a vertical axis (a Z axis), such that the suction nozzle 17 sucks and holds the component P. The component feed unit drive mechanism 27 drives each of the component feed units 21 such that the component feed unit 21 feeds the component P to a component feed port 21a (FIG. 2) of the component feed unit 21. The camera head travel mechanism 28 causes the Y-axis slider 14 for the camera head 20 to travel along the Y-axis table 13 and also causes the travel stage 16 for the camera head 20 (i.e., the camera head 20) to travel along the X-axis table 15. A controller 30 (see also FIG. 2) provided in the component placement machine 3 controls operation of the board conveyance path drive mechanism 24, the placement head travel mechanism 25, the suction nozzle operating mechanism 26, the component feed unit drive mechanism 27, and the camera head travel mechanism 28.

A portion including the placement head 18, the placement head travel mechanism 25, the suction nozzle operating mechanism 26, the component feed unit drive mechanism 27, and the controller 30 configures a component placing unit 31 serving as component placing means for placing the component P on the board PB (FIG. 4). A portion including the inspection camera 19, the camera head 20, the camera head travel mechanism 28, and the controller 30 configures an inspection unit 32 that serves as inspection means for performing an appearance check to the board PB prior to the placement of the component P so as to detect a defective portion N (see FIGS. 2 and 5) on the board PB (FIG. 4).

In FIG. 4, the controller 30 controls operation of the inspection camera 19, the board camera 22, and the component camera 23. Image data obtained by the inspection camera 19, the board camera 22, and the component camera 23 are sent to the controller 30. The controller 30 controls an operation for feeding the component P by each of the component feed units 21 through the component feed unit drive mechanism 27.

In the component placement machine 3, the controller 30 controls the operation of the board conveyance path 12 so as to receive the board PB conveyed from the solder coating machine 2 and to position the received board PB at the predetermined work position in the component placement machine 3. The controller 30 controls the operation of the placement head travel mechanism 25 so as to move the placement head 18 to the position above the board PB. The controller 3 controls the board camera 22 to capture an image of a board mark M (FIG. 2) on the board PB so as to determine a positional displacement of the board PB (positional displacement of the board PB from a normal work position).

When the component placement machine 3 determines the positional displacement of the board PB, the inspection unit 32 serving as inspection means of the component placement machine 3 operates the camera head travel mechanism 28 and the inspection camera 19 through the controller 30, and performs the appearance check to the board PB before the placement of the component P so as to detect the defective portion N on the board PB. The detection of the defective portion N is specifically performed as follows. The inspection camera 19 captures an image of each of the component placement positions L on the board PB coated with the solder S by the solder coating machine 2, thereby recognizing an image. When the solder S is not properly applied to the component placement positions L, for example, when the solder S is deviated from the component placement positions L (see a drawing within a frame of a broken line shown in FIG. 5), the portion is recognized as the defective portion N.

When the inspection unit 32 detects the defective portion N on the board PB, a defective portion image display unit 30a (FIG. 4) of the controller 30 controls the image display device 6 provided in the repair station 4 such that the image of the defective portion N detected by the inspection unit 32 is displayed on the image display device 6 through the LAN cable 9. The defective portion image display unit 30a controls the image display device 6 such that an image of the entire board PB showing the position of the defective portion N on the board PB and also an enlarged image of the defective portion N are displayed on the image display device 6. The image of the defective portion N may be displayed one at a time on the image display device 6, or images of a plurality of defective portions may also be collectively displayed thereon.

The operator performs the repair work of the board PB, which will be described later, at the repair station 4. The operator determines whether the defective portion N is true defective portion N based on the image of the defective portions N displayed on the image display device 6 by the defective portion image display unit 30a (i.e., while viewing the image of the defective portion N) and inputs the determination result through the input device 7. Details of the determination result input by the operator through the input device 7 are input to a repair required portion image display unit 30b (FIG. 4) of the controller 30 through the LAN cable 9.

On receipt of the determination result input by the operator, the repair required portion image display unit 30b decides, as a “repair required portion,” a defective portion which is indicated as the true defective portion N in the determination result input through the input device 7 and selected from the defective portion N (the component placement positions L determined to be defective by the inspection unit 32) detected by the inspection unit 32. The repair required portion image display unit 30b stores the image data pertaining to the decided defective portion N in a storage unit 30c (FIG. 4) along with data indicating a position of the defective portion on the board PB.

After the repair required portion image display unit 30b stores the image data of the “repair required portion” into the storage unit 30c along with the positional data, the component placing unit 31 serving as component placing means of the component placement machine 3 is controlled by the controller 30 so as to operate the placement head travel mechanism 25, the suction nozzle operating mechanism 26, the component feed unit drive mechanism 27, and the like, thereby placing the components P to the component placement positions L where the components P can be placed (specifically, the component placement positions L determined by subtracting the “repair required portions” stored in the storage unit 30c from the component placement positions L on the board PB to which the appearance check has been performed by the inspection unit 32).

In the placement of the components on the board PB, the component placing unit 31 controls the operation of the component feed unit drive mechanism 27 by the controller 30, thereby feeding the component P to the component feed port 21a of the component feed unit 21. Concurrently, the component placing unit 31 controls the operation of the placement head travel mechanism 25, thereby moving the placement head 18 and further moving the suction nozzle 17 to a position above the component feed port 21a. Next, the controller 30 controls the operation of the suction nozzle operating mechanism 26, thereby controlling the suction nozzle 17 of the placement head 18 to pick up (suck) the component P fed to the component feed port 21a. After the suction nozzle 17 picks up the component P, the controller 30 controls the operation of the placement head travel mechanism 25, thereby moving the placement head 18 to a position immediately above the component camera 23. The controller 30 then controls the component camera 23 to capture an image of the component P, thereby recognizing an image and determining a positional displacement (suction deviation) of the component P from the corresponding suction nozzle 17. After the positional displacement is determined, the controller 30 controls movement of the suction nozzle 17 so as to correct a difference between the determined suction deviation and the positional displacement of the board PB which has already been determined, whereby the components P are placed on the correct component placement positions L.

Such component placing operation is repeated by the component placing unit 31, whereby the components P are placed on all of the component placement positions L well coated with the solder S on the board PB (i.e., the positions except the “repair required portion”). After completing processing for placing component on the board PB, the component placement machine 3 conveys the board PB to the outside (the repair station 4) by the board conveyance path 12.

In FIGS. 1 and 2, the repair station 4 includes a board conveyance path 4a including a pair of belt conveyors configured to convey the board PB in the X-axis direction. A repair tool storage site 4b is provided in the repair station 4. The repair tool storage site 4b stores repair tool 4c used for repairing the board PB transferred from the component placement machine 3.

At the repair station 4, the operator repairs “repair required portion” on the board PB transferred from the component placement machine 3. The board PB is repaired; for example, by moving the solder S applied to positions deviated from the component placement positions L on the board PB to correct positions using the repair tool 4c stored in the repair tool storage site 4b.

After the board PB having the “repair required portion” is transferred to the repair station 4, that is, when the operator performs the repair work of the board PB at the repair station 4, the repair required portion image display unit 30b of the component placement machine 3 reads an image of the “repair required portion” stored in the storage unit 30c (an image of the defective portions N which is indicated as the true defective portion N in the determination result input through the input device 7, of the defective portion N on the board PB detected by the inspection unit 32) and displays the read image on the image display device 6. By virtue of the display, the operator who performs the repair work for the board PB at the repair station 4 can perform required work while viewing the image of the “repair required portion” displayed on the image display device 6; namely, while visually checking the component placement positions L on the board PB to be repaired and the defective state of the component placement positions to be repaired.

If the inspection unit 32 has detected the defective portion N by the appearance check of the board PB, the defective portion image display unit 30a displays the image of the defective portion N detected by the inspection unit 32, even while the repair work of the board PB is currently performed at the repair station 4 and while the image of the “repair required portion” of the board PB is displayed on the image display unit 8 by the repair required portion image display unit 30b. At this time, the defective portion image display unit 30a may display the image of the defective portions N in place of (by switching a screen) the displayed image of the “repair required portion” currently provided on the image display device 6 by the repair required portion image display unit 30b. Alternatively, the defective portion image display unit 30a may display an image of the defective portion N along with the image of the “repair required portion” currently displayed on the image display device 6. A conceivable method for displaying the image of the defective portion N on the image display device 6 along with an image of the “repair required portion” includes a method for dividing a screen and displaying the images on the divided sub-screens, a method for displaying an image of the defective portion N on a pop-up window over a screen indicating the image of the “repair required portion,” or the like.

Of the boards PB transferred from the component placement machine 3 to the repair station 4, the board PB with no defective portion N detected through the appearance check of the inspection unit 32 of the component placement machine 3 are transferred, as it is, to the reflow oven 5 by the board conveyance path 4a of the repair station 4. On the other hand, the board PB with the defective portion N detected through the appearance check of the inspection unit 32 of the component placement machine 3 is repaired by the operator at the repair station 4, and thereafter is again placed into the component placement machine 3 after having been. In other words, of the boards PB passed through the component placement machine 3, only the boards PB with no “repair required portion” are transferred to the reflow oven 5.

In FIG. 1, the reflow oven 5 includes a board conveyance path 5a including a pair of belt conveyors configured to convey the board PB in the X-axis direction. The reflow oven 5 carries the board PB received by the board conveyance path 5a in the X-axis direction, and also performs reflow processing to the solder S on the board PB.

As described above, the component mount system 1 of the present embodiment includes: the component placing unit 31 serving as component placing means for placing the component P on the board PB; the inspection unit 32 serving as inspection means for detecting a defective portion N on the board PB by performing appearance check of the board PB before a placement of the component by the component placing unit 31; the repair station 4 in which a repair work is performed for the board PB which is transferred after the appearance check is performed by the inspection unit 32; the image display device 6 on which an image is displayed; the defective portion image display unit 30a of the controller 30 serving as defective portion image display means for displaying an image of the defective portion N on the board PB detected by the inspection unit 32 on the image display device 6; the input device configured to input a result of a determination made by the operator who repairs the board PB at the repair station 4 whether the defective portion N is true a defective portion N based on the image of the defective portions N displayed on the image display device 6 by the defective portion image display unit 30a; and the repair required portion image display unit 30b of the controller 30 serving as repair required portion display means for displaying the defective portion N, which is indicated as a true defective portion in the determination result input through the input device 7 and selected from the defective portion N on the board PB detected by the inspection unit 32, as a “repair requiring portion.” The image display device 6 is provided at a location where the operator who performs the repair work for the board PB at the repair station 4 can (easily) watch the image displayed on the image display device 6. The input device 7 is provided at a location where the operator who performs the repair work for the board PB at the repair station 4 can (easily) operate the input device 7.

Accordingly, in the component mount system 1 of the present embodiment, the image display device 6 on which the image of the defective portion N on the board PB detected by the inspection unit 32 is displayed is provided at a location where the operator who performs the repair work for the board PB at the repair station 4 can (easily) watch the image displayed on the image display device 6. Further, in the system, the input device 7 configured to input a true/false determination about the defective portion N based on the image of the defective portion N displayed on the image display device 6 is provided at a location where the operator who performs the repair work for the board PB at the repair station 4 can (easily) operate the input device 7. The operator who performs the repair work for the board PB at the repair station 4 can check the defective portion N through the image while performing repair of the board, thereby making the true/false determination. Therefore, the component mount system 1 of the present embodiment can allow one operator to perform the repair work for the board PB and the true/false determination work for the detects defective portion N on the board PB, so that working efficiency can be enhanced.

It is sufficient to provide the image display device 6 and the input device 7 at the location where the operator who performs the repair work for the board PB at the repair station 4 can watch the image and the location where the operator can perform the input device 7, respectively, and the image display device 6 and the input device 7 are not necessarily provided at the repair station 4 as in the present embodiment. However, it is preferable to provide the image display device 6 and the input device 7 at the repair station 4, since so long as the image display device 6 and the input device 7 are provided at the repair station 4 as in the present embodiment, the operator who performs the repair work for the board PB at the repair station 4 can watch the image displayed on the image display device 6 and can operate the input device 7 without moving from the work location (hence without interrupting his/her work).

In the component mount system 1 of the present embodiment, the repair required portion image display unit 30b of the controller 30 serving as repair required portion display means for storing an image of the repair required portion into the storage unit 30c of the controller 30 serving as storage means. After the board PB having the repair required portion has been transferred to the repair station 4, the image of the repair required portion on the board PB is read from the storage unit 30c and displayed on the image display device 6. Therefore, the operator who performs the repair work for the board PB at the repair station 4 repair the board PB while visually checking a state of the defective portion N (the repair required portion) on the board PB under repair through the image displayed on the image display device 6, so that operability is enhanced.

In the component mount system 1 of the present embodiment, the inspection unit 32 and the component placing unit 31 are provided in one component placement machine 3 configured to perform the appearance check of the board PB and places the component on the board PB while positioning the board PB at one work position. The inspection unit 32 performs the appearance check of the board PB before the placement of the component P, for detecting the defective portion of the component placement positions L on the board PB. The component placing unit 31 places the components P on the component placement positions L determined by subtracting the “repair required portions” from the component placement positions L on the board PB to which the appearance check is performed by the inspection unit 32. Therefore, it is possible to place the components P on the component placement positions L that are not the defective portions N while the inspection unit 32 simultaneously performs the appearance check of the board PB. Further, since the inspection means (the inspection unit 32 in the embodiment) and the component placing means (the component placing unit 31 in the embodiment) are respectively provided in different machines (e.g., an inspection machine and a component mounting machine), when compared with the component mount system in which the two machines are provided in series, productivity of the board PB can be significantly enhanced.

Although the embodiment of the present invention has been described, the present invention is not limited to the embodiment described above. For example, in the embodiment, the inspection means for detecting the defective portion N on the board PB by performing the appearance check of the board PB detects the defective portions on the board PB by performing the appearance check of the board PB before the placement of the component P by the component placing means. However, the inspection means may detect a defective portion on the board PB by performing the appearance check of the board PB after the placement of the component P by the component placing means. In this case, repair of the board PB performed at the repair station 4 mainly includes a correction to positional displacement of the component P, for example, a correction for shifting the component P deviated from the component placement position L on the board PB to a correct position by use of the repair tool 4c, etc., stored in the repair tool storage site 4b.

In the present embodiment, the repair required portion image display unit 30b of the controller 30 serves as the repair required portion display means. The image of the repair required portion is stored in storage means (the storage unit 30c of the controller 30), and the board PB having the repair required portion is transferred to the repair station 4. Subsequently, the image of the repair required portion on the board PB is read from the storage means and displayed on the image display device 6. However, this is a mere example. It is sufficient for the repair required portion image display means to display, as a “repair required portion,” the defective portion N indicated as the true defective portion N in the determination result input through the input device 7 selected from the defective portion N on the board PB detected by the inspection means (the inspection unit 32 in the embodiment). For example, the repair required portion image display means may be configured different from the means described in the embodiment, for example, means for providing the “repair required portion” with a mark which is viewable from the outside.

The present invention is not limited to the present embodiment. It is intended that various changes or applications be made by a person having ordinary skill in the art based on from the descriptions of the present patent application and the known techniques and be included within a scope in which protection is sought.

The present patent application is based on Japanese Patent Application (No. 2008-182228 filed on Jul. 14, 2008, the entire contents of which is incorporated herein by reference.

### INDUSTRIAL APPLICABILITY

There is provided a component mount system which allows one operator to perform a board repair work and a true/false determination work for a detected defective portion on a board, thereby enhancing working efficiency.

### DESCRIPTION OF REFERENCE SIGNS

1 COMPONENT MOUNT SYSTEM
3 COMPONENT PLACEMENT MACHINE
4 REPAIR STATION
6 IMAGE DISPLAY DEVICE
7 INPUT DEVICE
30a DEFECTIVE PORTION IMAGE DISPLAY UNIT (DEFECTIVE PORTION IMAGE DISPLAY MEANS)
30b REPAIR REQUIRED PORTION IMAGE DISPLAY UNIT (REPAIR REQUIRED PORTION DISPLAY MEANS)
30c STORAGE UNIT (STORAGE MEANS)
31 COMPONENT PLACING UNIT (COMPONENT PLACING MEANS)
32 INSPECTION UNIT (INSPECTION MEANS)
PB BOARD
L COMPONENT PLACEMENT POSITION
N DEFECTIVE PORTION
P COMPONENT

1. A component mount system comprising:
a component placing unit configured to place a component on a board;
an inspection unit configured to detect a defective portion on the board by performing appearance check of the board before or after a placement of the component by the component placing unit;
a repair station in which a repair work is performed for the board which is transferred after the appearance check is performed by the inspection unit;
an image display device on which an image is displayed;
a defective portion image display unit configured to display an image of the defective portion of the board detected by the inspection unit on the image display device;
an input device configured to input a determination result by an operator who performs the repair work for the board at the repair station as to the image of the defective portion displayed on the image display device by the defective portion image display unit; and
a repair required portion display unit configured to display a defective portion, which is indicated as a true defective portion in the determination result input through the input device and selected from the defective portion on the board detected by the inspection unit, as a repair required portion on the image display device,
wherein the image display device is provided at a location where the operator who performs the repair work for the board at the repair station can watch the image displayed on the image display device, and the input device is provided at a location where the operator who performs the repair work for the board at the repair station can operate the input device.

2. The component mount system according to claim 1, wherein the image display device and the input device are provided at the repair station.

3. The component mount system according to claim 1, wherein the repair required portion display unit stores an image of the repair required portion in a storage unit, reads the image of the repair required portion on the board from the storage unit after the board with the repair required portion is transferred to the repair station, and displays the read image on the image display device.

4. The component mount system according to claim 1,
wherein the inspection unit and the component placing unit are provided in a single component mounting machine configured to perform the appearance check of the board and places the component on the board while positioning the board at a work position,
wherein the inspection unit performs the appearance check of the board before the placement of the component, for detecting the defective portion of a component placement position on the board, and
wherein the component placing unit places the component on a component placement position determined by subtracting the repair required portion from the component placement position on the board to which the appearance check is performed by the inspection unit.

5. A component mount method for a component mount system comprising: a component placing unit configured to place a component on a board; an inspection unit configured to detect a defective portion on the board by a performing appearance check of the board before or after a placement of the component by the component placing unit; a repair station in which a repair work is performed for the board which is transferred after the appearance check is performed by the inspection unit; an image display device which is provided at a location where an operator who performs the repair work for the board at the repair station can watch the image display device and on which an image is displayed; and an input device which is provided at a location where the operator can perform input operation and which is configured to input a determination result by the operator, said method comprising:
displaying an image of a defective portion on the board detected by the inspection unit on the image display device;
inputting the determination result by the operator as to the image of the defective portion displayed on the image display device through the input device;
displaying a defective portion input as the determination result showing a true defective portion of the defective portion on the board detected by the inspection unit on the image display device as a repair required portion;
placing the component on a component placement position on the board except the repair required portions by the component placing unit; and
conveying the board after the placement of the component to the repair station.
